(19) United States
(12) Patent Application Publication
(10) Pub. No.: US 2008/0111968 A1
(43) Pub. Date: May 15, 2008

(54) Top-bifocal readers aka piano glasses

(76) Inventor: Farrell Fern Burk, Brooklyn, NY (US)

Correspondence Address: Farrell Burk, 5 Delavan Street Apt 2-i, Brooklyn, NY, 11231, US

(21) Appl. No.: 11/978,064

(22) Filed: Oct. 27, 2007

Related U.S. Application Data
(60) Provisional application No. 60/855,637, filed on Oct. 31, 2006.

(51) Int. Cl. G02C 7/06

(52) U.S. Cl. 351/168

(57) ABSTRACT

Over the counter bifocal reading glasses where the magnified bifocal area is located in the top portion of the lens, while the bottom portion of the lens remains with no magnification (plano). This reverse configuration of previous OTC bifocals will magnify the user's upper visual field so as to accommodate for normal visual loss associated with aging. (Presbyopia) Musicians and computer users, whose reading material is placed at or above eye level, will benefit from the high placement of the magnified bifocal. Likewise, the bottom plano portion of the lens would help these users avoid the discomfort and distortion associated with looking at close up, large objects through magnified lenses; objects such as their hands, computer keyboard and piano.

### CROSS-REFERENCE TO RELATED APPLICATIONS

Provisional application No. 60/855,637

Filing date Oct. 31, 2006

Relationship of the applications—I am filing a non-provisional application with hopes to receive the benefits of the preceding provisional application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Presbyopia is the normal loss of elasticity of the lens of the eye, which makes it difficult to focus on small, near objects. Most people experience presbyopia at around 40 years old. Like wrinkles, it is a normal part of the aging process and not a disease.

By magnifying text, reading glasses have long been used to overcome Presbyopia. At least 20 years ago, over the counter reading glasses became popular because they could be obtained without a prescription and the mass production of standard diopters significantly lowered the price.

Reading lenses usually distort distance vision and this fact has historically influenced the design of OTC readers. Most readers available today are 1¼″ or less in height so that the user can look down when they want to read, or peer over the lenses when they want to look distance. One popular style of the OTC reading glass is the bifocal, which are constructed with a magnification area on the bottom portion of the lens. The top portion of the lenses have no magnification (piano). This enables the user to read materials placed below eye level, yet peer through the non-magnified portion on top when they look at far away objects.

There are, however, unique circumstances in which the Presbyopic has a need for the upper half of the lenses to be magnified and lower half piano. One example of a presbyopic with unique visual needs is the musician. Many musicians place their sheet music at or above eye level. OTC readers available today force them to put their heads in uncomfortable positions and risk neck strain. However, the invention set forth in this application would enable them to look through the upper half of their glasses without accompanying strain. Also to take into consideration is the piano bottom portion. Like distance vision, reading lenses can also distort large, close up objects, in this case being hands playing musical instruments such as the piano. The piano bottom portion of the lenses in this invention helps the user avoid such distortion and visually associated discomfort.

In the past decade, the popularity of the personal computer has increased this need exponentially wherein the computer user's upper visual field requires magnification to accommodate their intermediate reading vision, while their lower visual field needs to remain unmagnified as to prevent the distortion of close up, large objects such as their hands and computer keyboard.

### BRIEF SUMMARY OF THE INVENTION

In summary, this invention reverses the normal construction of ready-to-wear bifocal reading glasses, so that the top portion of the lens is magnified and the lower portion is piano. The advantage is that there will finally be ready-to-wear (or OTC) reading glasses to help people who need magnification in the upper half of their field of vision, and need the bottom portion to remain unmagnified in order to avoid distortion of up-close large objects. Examples of users who will benefit are musicians reading sheet music placed at or above eye level, and computer users with monitors at or above eye level. The ready-to-wear reading glass industry already caters to people with standard Presbyopia with glasses that magnify text held below eye level. The object of this invention is to also help Presbyopic people who need to hold their reading material above eye level.

### BRIEF DESCRIPTION OF THE SEVERAL VIEWS OF THE DRAWING

FIG. 1 Drawing of Top-Bifocal readers with bifocal lenses affixed to eyeglass frame.

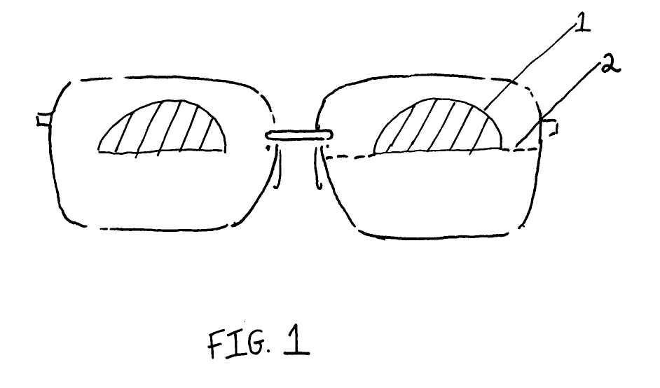

1—Depicts the half moon shaped bifocal as located in the top portion of the frame and oriented so the convexity is pointing upward. This moon shape bifocal can be 28, 35 or 45 mm across at its widest.

2—Represents the midpoint of the lens or datum to illustrate the position of the bifocal

FIG. 2 Drawing of Top-Bifocal Readers made from the same frame as FIG. 1, but with different shape bifocal, commonly known to those experienced in the art of making eyeglasses as “Executive Bifocals”.

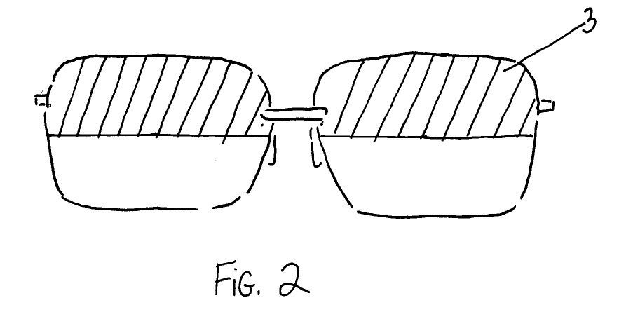

3—Executive bifocals have a line which extends horizontally across the entire lens, and in this case magnifies the area of the entire upper portion.

FIG. 3 Drawing of Top-Bifocal Readers made from different, aviator style frame.

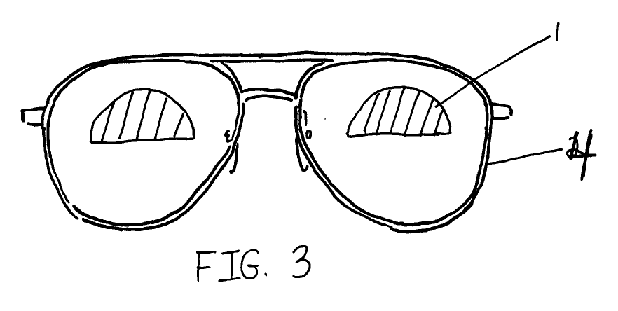

1—Half-moon bifocal

4—Aviator shape frame to demonstrate how Top-Bifocal Readers can be ground to fit any shape frame.

FIG. 4 Drawing of Top-Bifocal Readers made from rectangular shaped plastic frame

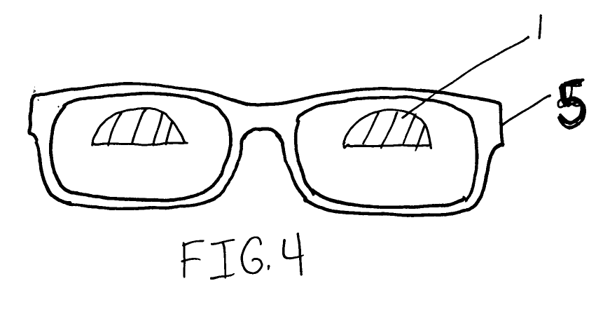

1—Half-moon bifocal

5—Rectangular frame further demonstrates how Top-Bifocal Readers can be ground to fit any shape frame.

FIG. 5 View of what musician may see when wearing standard, full sized over the counter reading glasses.

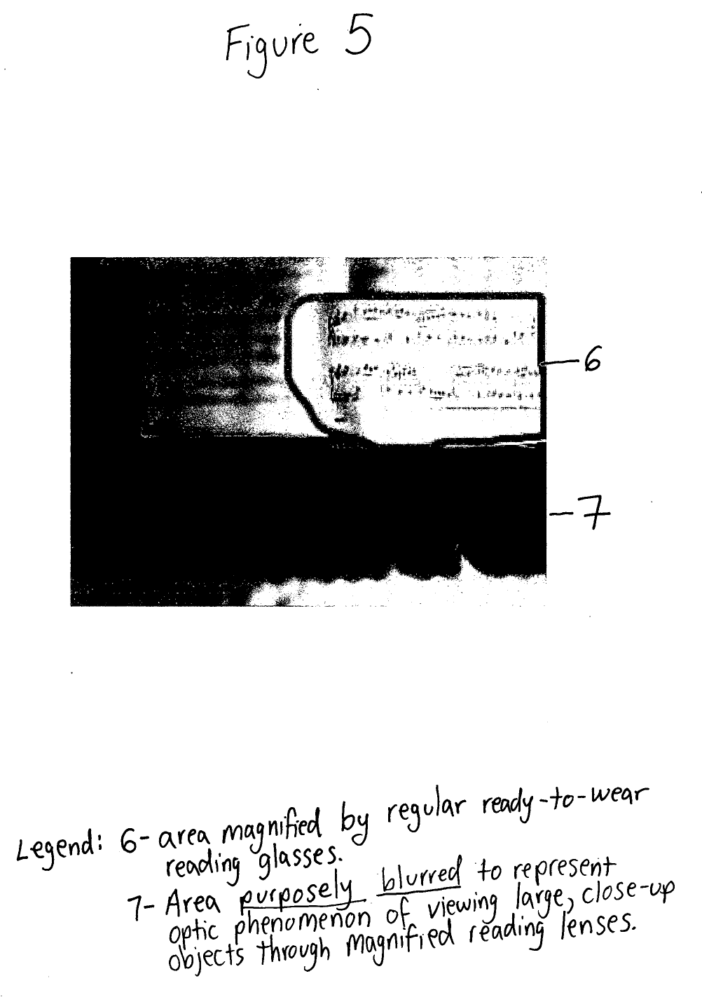

6—The circled area of text is magnified because the glasses help accommodate for near-vision loss associated with Presyopia

7—However, the close-up large objects, such as the hands and piano keys, are distorted from this same magnification.

FIG. 6 How this same view can be clarified for the musician when wearing invention embodied in this specification.

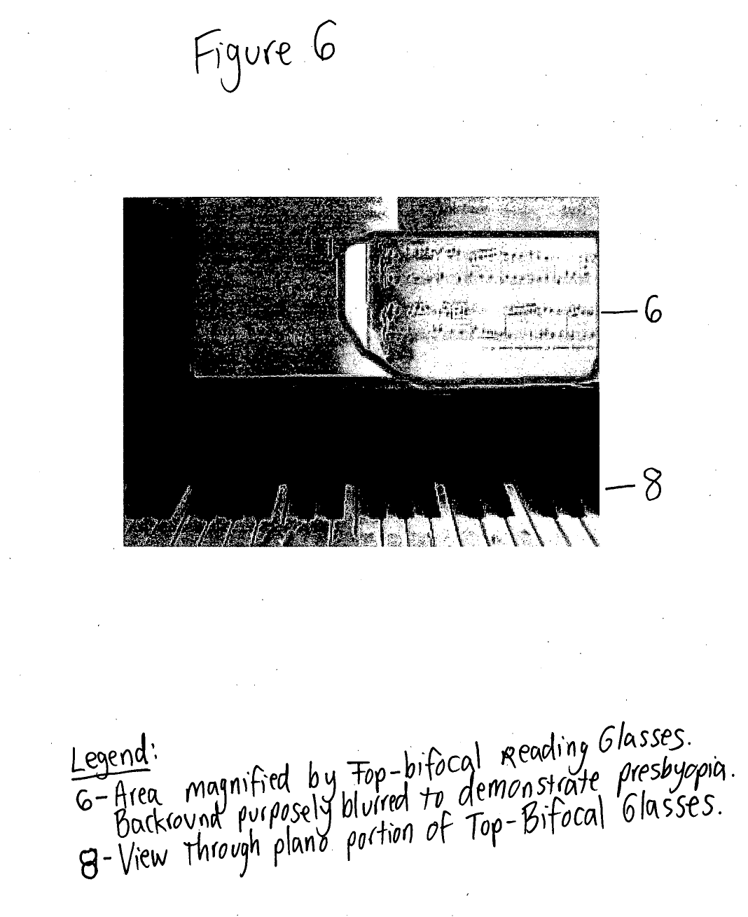

6—As before, the circled area of text is magnified by the reading glasses.

8—However, the plano portion of the lens on the bottom assures that the hands and piano keys remain distortion free.

FIG. 7 View of what computer user may see when wearing standard, full sized over the counter reading glasses to correct intermediate vision worsened by Presbyopia

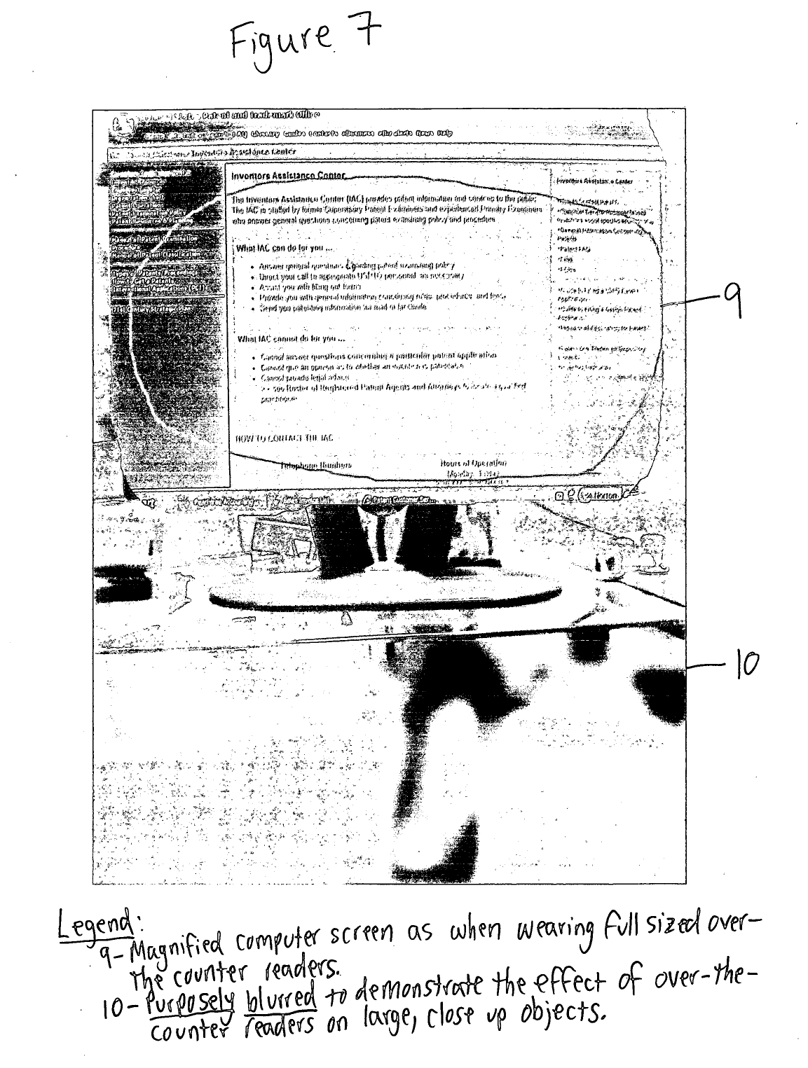

9—The circled area of text is magnified because the glasses help accommodate for near-vision loss associated with Presyopia

10—However, the close-up large objects, such as the computer keyboard, are distorted from this same magnification.

FIG. 8 How this same view can be clarified for the computer user when wearing invention embodied in this specification.

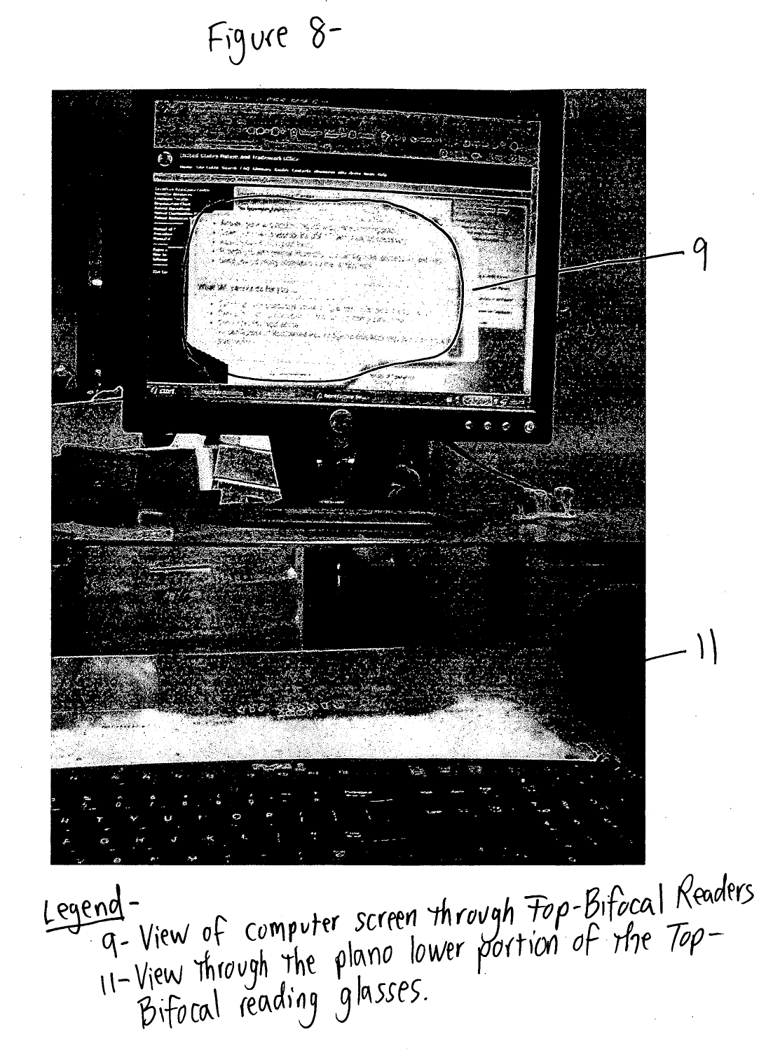

9—As above, the text on the computer screen is magnified by standard OTC reading glasses.

11—However, the plano portion of the lens on the bottom assures that the hands and computer keyboard remain distortion free.

### DETAILED DESCRIPTION OF THE INVENTION

The difference in the construction of these lenses, as compared to the customary bottom-bifocals, is that the lenses are shaped in such a way that the magnified portion is positioned in the TOP half of the lens, and the bottom remains without magnification. As anyone skilled in the art of making reading glasses will know, this is the REVERSE of standard ready-to-wear bifocal reading glasses.

OTC bifocal reading lenses are commonly made by fusing 2 parts together. The “carrier lens”, or larger portion, is made by injecting plastic into a mold. The “button” or magnified bifocal portion is made by grinding down another piece of plastic until it has the desired refraction properties, or magnification. Both pieces are then cemented together. A further step needs to occur to make reading glasses. The lenses, in the case of embodied invention, plano with a magnified button, now need to be ground to the fit the eyeglass frame, or in the case of rimless frames, ground to the desired shape. It is in this step of the manufacturing of OTC reading glasses that the embodied invention is new and unique, as far as the inventor has knowledge. This is the point where the optician or manufacturer takes aforementioned lenses and turns them, either clockwise or counter clockwise, 180 degrees from the customary position, so that its orientation compared to the lens pattern is upside down from what is ordinary. This way, the bifocal portion will be located at the top portion of the lens when shaped, and will remain in the top portion when affixed to the frame.

The actual material of the lens can be molded from any material that is used in common OTC reading glasses, including but not limited to CR39, CR38. The lenses can also be treated in ways including but not limited to scratch resistant coating, melanin tinted, or UV shaded.

The strengths of the bifocal of this invention will be standard OTC diopters of +0.50, +0.75, +1.00, +1.25, +1.50, +1.75, +2.00, +2.25, +2.50, +2.75, +3.00, +3.25, +3.50, +3.75 and +4.00 This will assure that a wide range of people with presbyopia, from mild to strong, can be helped by this product. Also, when the right lens has an equal strength to the left, the glasses are readily available to the public and do not require a prescription, just like standard ready-to-wear readers.

The aforementioned diopters may or may not coincide with the user's typical reading glass strength, because the Top-Bifocal Readers are designed to help accommodate intermediate vision. Intermediate vision magnification is approximately 50% of the magnification needed for close-up reading. Presbyopics can determine their intermediate reading magnification just as they now determine close-up reading needs; either through trial and error, eye charts, or assessment by an eye professional. An eye chart and conversion scale which estimates intermediate vision depending on factors including near-vision diopter and distance to reading material will be available with this product.

This item is designed to help people with normal vision loss associated with age, or Presbyopia. (It is not designed for people with special visual needs such as low vision, astigmatism, or other conditions causing asymmetrical, or extreme, vision loss.) Of these people with standard Presbyopia, the Top Bifocal Reading Glasses are designed to help those whose habits call for them to read at or above eye level. Examples of reading material that is customarily read at or above eye level include sheet music and computer monitors. This is counter-intuitive to our standard reading patterns, where a book or newspaper is placed on the desk, or held, below eye level. Since in this invention, the magnification is on the TOP portion of the lens, it will help Presbyopic musicians read sheet music at or above eye level, and help Presbyopic computer users see their monitors.

Equally important in the design of the Top Bifocal Reading Glasses is the fact that the bottom half of the lens is PLANO, or has +0 magnification. Anyone who needs the magnification on the top portion of their visual field can simply wear large reading glasses wherein the entire lens is magnified. This way the entire visual field is magnified. However, magnification in the lower field of vision would be disadvantageous for the musician and computer user for the following reason: Looking at large objects, even at a close distance, through magnified reading glasses can cause distortion and/or eye discomfort. Thus, the musician who looks at sheet music through magnified reading glasses will experience distortion or discomfort when looking through the same magnification at his/her hands and instrument. Likewise, a writer will look comfortably at the computer monitor through the magnified lenses of reading glasses will experience discomfort when the gaze is moved down to the hand that is writing on the desk below. Also, many computer users place printed material at the same distance as the computer, in which case the magnification would assist in the reading of this material as well as the computer monitor. Furthermore, the plano aspect of the invention assures that these readers can be mass produced, low in cost, and over the counter, thereby making the Top-Bifocal readers ready available to those it will help without the need for a prescription.

The embodiments of the invention in which an exclusive property or privilege is claimed are defined as follows:

1. OTC Bifocal reading glasses consisting of lenses constructed so that bifocals having magnification to correct for presbyopia for intermediate range viewing are located in the upper half of said lenses, leaving the lower half with +0 power (plano) before getting affixed to the eyeglass frame.

2. The bifocal glasses in claim one wherein said bifocal has magnification which corresponds with the near vision needs of the wearer.

3. The bifocal reading glasses in claim one wherein said bifocal has a placement on the lens of datum ½+, where + signifies “above” the midline which includes the exact midpoint as well as, but not limited to, datum +1 and datum +2.

4. The bifocal reading glasses in claim one wherein said bifocal is half moon shape Ft 28 bifocal, aka standard size half moon shape, which is 28 mm across.

5. The bifocal reading glasses in claim one wherein said bifocal is half moon shape Ft 35, or 35 mm across.

6. The bifocal reading glasses in claim one wherein said bifocal is half moon shape Ft 45, or 45 mm across.

7. The bifocal reading glasses in claim one wherein said bifocal is Executive, wherein the line extends across the entire lens.

8. The bifocal reading glasses in claim one wherein said bifocal is progressive.

9. The bifocal reading glasses in claim 1 wherein the said lenses are of CR39

10. The bifocal reading glasses in claim one wherein they are constructed with optical, distortion free lenses

11. The bifocal reading glasses in claim one, wherein the lenses are scratch-resistant coated.

12. The bifocal reading glasses in claim 11 wherein the said lenses are CR38

13. The bifocal reading glasses in claim one wherein the lenses are acrylic and CR 38
